(19) United States
(12) Patent Application Publication
(10) Pub. No.: US 2016/0291370 A1
(43) Pub. Date: Oct. 6, 2016

(54) PARTITIONED DISPLAY AND CONTROL TO PROVIDE POWER MANAGEMENT IN LIQUID CRYSTAL DISPLAY

(71) Applicant: GOOGLE INC., Mountain View, CA (US)

(72) Inventors: Ken Foo, Sunnyvale, CA (US); Sameer Nanda, San Jose, CA (US)

(21) Appl. No.: 14/676,598

(22) Filed: Apr. 1, 2015

(51) Int. Cl. G02F 1/133; G09G 3/36; G09G 3/34

(52) U.S. Cl. CPC G02F 1/13318; G09G 3/3406; G09G 3/36; G09G 2320/0626; G09G 2320/066; G09G 2360/144

(57) ABSTRACT

A computing device includes a backlight display having a plurality of light sources, each light source being associated with at least one, but not all, of a plurality of different individual regions of the backlight display. The computing device includes a display controller configured to turn on at least one of the plurality of light sources, while other ones of the light sources are not turned on, to provide backlight illumination to an individual region of the backlight display associated with the light source(s) that are turned on, while not providing backlight illumination to one or more other individual regions of the backlight display. The computing device includes an event handler configured to detect an occurrence of an event that may be handled by a program installed on the computing device. The computing device includes a notification engine configured to, in response to the event handler detecting the occurrence of the event, provide a first visual notification to a user of the detection of the event on the backlight display, wherein the first visual notification is provided within a region of the backlight display that is provided with backlight illumination while backlight illumination is not provided to the one or more other individual regions of the backlight display.

### BACKGROUND

Computing devices may use backlight display devices to display information to a user. The backlight can consume a significant amount of energy, especially when the brightness of the display is high, and therefore it is desirable to manage the power consumption of the backlight display carefully, especially in a computing device that relies on a battery for its power.

Modern computing devices often are expected to continually provide information to a user of the device, for example, in the form of notifications of various events monitored by the computing device (e.g., incoming messages from other users (e,g, email, text, phone, chat), messages from applications run in foreground or background by the computing device, upcoming calendar events, alarms, etc.). Because of this, the backlight may be required frequently to provide such notifications to the user. Energy can be conserved by using a low brightness of the backlight when the computing device displays a notification, but a low backlight brightness often results in a poor reading experience. And with the backlight being used frequently to provide notifications to the user, turning the display off between different notifications may not save much power.

Thus, a need exists to address the limitations of the existing art.

### SUMMARY

The details of one or more implementations are set forth in the accompanying drawings and the description below. Other features will be apparent from the description and drawings, and from the claims.

In a first aspect, a computing device includes a backlight display having a plurality of light sources, each light source being associated with at least one, but not all, of a plurality of different individual regions of the backlight display. The computing device includes a display controller configured to turn on at least one of the plurality of light sources, while other ones of the light sources are not turned on, to provide backlight illumination to an individual region of the backlight display associated with the light source(s) that are turned on, while not providing backlight illumination to one or more other individual regions of the backlight display. The computing device includes an event handler configured to detect an occurrence of an event that may be handled by a program installed on the computing device. The computing device includes a notification engine configured to, in response to the event handler detecting the occurrence of the event, provide a first visual notification to a user of the detection of the event on the backlight display, wherein the first visual notification is provided within a region of the backlight display that is provided with backlight illumination while backlight illumination is not provided to the one or more other individual regions of the backlight display.

Implementations can include one or more of the following features, alone, or in combination with other features. For example, the plurality of different individual regions can be adjacent to each other. The notification includes one of an incoming call, incoming call email, incoming call SMS message, or a reminder of calendar event.

The computing device can include a base portion and a display portion, the display portion including the backlight display, and the base portion including a keyboard. An area of the backlight display can be greater than five square inches, and the plurality of different individual regions of the backlight display can include at least three different individual regions. The plurality of different individual regions of the backlight display can include at least three different regions, and the areas of the different regions can be approximately equal.

The display controller can be further configured to: sequentially turn on one of more different ones of the plurality of light sources, while other ones of the light sources are not turned on, to sequentially provide backlight to different individual regions of the backlight display associated with the different light sources that are sequentially turned on, while not providing backlight to one or more other individual regions of the backlight display, and to sequentially provide the first visual notification to the user within the different regions of the backlight display that are provided with backlight.

The computing device can further include an ambient light sensor, and the display controller can be further configured to control, based on an ambient light level detected by the sensor, a brightness of the light sources that are turned on.

The computing device can include a user input handler configured to receive a user's selection of the first visual notification, and the display controller can be further configured to, in response to the received user's selection, turn on at least some of the light sources that had not been turned on to provide backlight illumination to all of the individual regions of the backlight display, where a brightness of the backlight illumination provided to each of the individual regions is approximately equal.

The display controller can be further configured to turn on multiple ones of the light sources to provide backlight to all the individual regions of the backlight display, where a brightness of the backlight provided to each of the individual regions is approximately equal.

The notification engine can be further configured to, in response to the event handler detecting the occurrence of the event when multiple ones of the light sources are turned on to provide backlight illumination to all the individual regions of the backlight display, provide, to the user, a second visual notification of the detection of the event on the backlight display, where the second visual notification can be different than the first visual notification. The notification engine can be configured to provide the first visual notification for a first time period when backlight illumination is not provided to the one or more other individual regions of the backlight display, and the notification engine can be configured to provide the second visual notification for a second time period when backlight illumination is provided to all of the individual regions of the backlight display, where the first time period is longer than the second time period.

In another aspect, a method provides a notification in a computing device having a backlight display that includes a plurality of light sources, each light source being associated with at least one, but not all, of a plurality of different individual regions of the backlight display. The method includes turning on at least one of the plurality of light sources, while other ones of the light sources are not turned on, to provide backlight illumination to an individual region of the backlight display associated with the light source(s) that are turned on, while not providing backlight illumination to one or more other individual regions of the backlight display. The method includes detecting an occurrence of an event that may be handled by a program installed on the computing device, and providing, in response detecting the occurrence of the event, a first visual notification to a user of the detection of the event on the backlight display, wherein the first visual notification is provided within a region of the backlight display that is provided with backlight illumination while backlight illumination is not provided to the one or more other individual regions of the backlight display.

Implementations can include one or more of the following features, alone, or in combination with other features. For example, the notification can include one of an incoming call, incoming call email, incoming call SMS message, or a reminder of calendar event. The method can further include sequentially turning on one of more different ones of the plurality of light sources, while other ones of the light sources are not turned on, to sequentially provide backlight to different individual regions of the backlight display associated with the different light sources that are sequentially turned on, while not providing backlight to one or more other individual regions of the backlight display, and sequentially providing the first visual notification to the user within the different regions of the backlight display that are provided with backlight.

The method can include detecting an ambient light level at the computing device, and based on the detected ambient light level, determining a brightness of the light sources that are turned on. The method can include receiving a user's selection of the first visual notification, and, in response to the received user's selection, turning on at least some of the light sources that had not been turned on to provide backlight illumination to all of the individual regions of the backlight display, wherein a brightness of the backlight illumination provided to each of the individual regions is approximately equal. The method can include, in response detecting the occurrence of the event when multiple ones of the light sources are turned on to provide backlight illumination to all the individual regions of the backlight display, providing, to the user, a second visual notification of the detection of the event on the backlight display, wherein the second visual notification is different than the first visual notification.

The method can include providing the first visual notification for a first time period when backlight illumination is not provided to the one or more other individual regions of the backlight display, and providing the second visual notification for a second time period when backlight illumination is provided to all of the individual regions of the backlight display, where the first time period is longer than the second time period.

In another general aspect, a computing device includes a backlight display including a plurality of light sources, each light source being associated with at least one, but not all, of a plurality of different individual regions of the backlight display, and a display controller. The display controller is configured to: (a) turn on at least one of the plurality of light sources, while other ones of the light sources are not turned on, to provide backlight illumination to an individual region of the backlight display associated with the light source(s) that are turned on, while not providing backlight illumination to one or more other individual regions of the backlight display, and (b) turn on multiple ones of the light sources to provide backlight illumination to all the individual regions of the backlight display, wherein a brightness of the backlight provided to each of the individual regions is approximately equal. The computing device includes one or more processors configured to execute a content rendering program, and a content mediation agent configured to determine a version of content requested by the content rendering program to be rendered by the program, where the determination of the version to be rendered is based on whether backlight illumination is provided to all the individual regions of the backlight display or whether backlight illumination is provided to an individual region of the backlight display, while backlight illumination is not provided to other regions of the display.

Implementations can include one or more of the following features, alone, or in combination with other features. For example, the content-rendering program can include a browser; the content requested to be rendered can include content from a webpage; a version of the content from the webpage to be rendered when backlight illumination is provided to all the individual regions of the backlight display can include a version of the webpage intended for rendering on displays having a diagonal dimension of greater than eight inches, and a version of the content from the webpage to be rendered when backlight illumination is provided to an individual region of the backlight display, while backlight illumination is not provided to other regions of the display can include a version of the webpage intended for rendering on displays having a diagonal dimension of less than five inches. Determining the version of content to be rendered can include specifying a browser user agent that is communicated from the computing device to a server hosting the content.

### BRIEF DESCRIPTION OF THE DRAWINGS

FIG. 1 is an example cross-sectional schematic diagram of a pixel element of a liquid crystal display.

FIG. 2 is a schematic perspective view of a light guide panel and a diffuser.

FIG. 3 is a schematic top view of the backlight section of a display device, according to an example implementation.

FIG. 4A, FIG. 4B, FIG. 4C, FIG. 4D are schematic diagrams of the display of information on an individual region of a backlight display with, while other regions of the backlight display are not provided with backlight illumination.

FIG. 5 is a schematic diagram of a computing device that includes a backlit display that is illuminated by a plurality of light sources.

FIG. 6 is a flowchart illustrating example operations of a process of providing a notification in a computing device having a backlight display that includes a plurality of light sources.

FIG. 7 shows an example of a computer device and a mobile computer device, which may be used with the techniques described here.

### DETAILED DESCRIPTION

Liquid crystal display (LCD) devices are used in a variety of applications, such as in televisions, computer monitor display devices, tablet display devices, mobile phone, and smart phone displays. LCD devices are energy efficient when compared with other types of displays, and they can be thinner than many other types of displays. Most LCDs include a layer of liquid crystal molecules aligned between two transparent electrodes, and two polarizing filters whose axis of transmission are perpendicular to each other. A source of light is provided to the LCD, and the amount of light that passes through the LCD can be controlled by controlling an electric field between the two transparent electrodes, which, in turn, controls the orientation of the liquid crystal molecules and therefore the amount of light that passes through the LCD.

An LCD device can include many individually-controllable pixel elements. By controlling the amount of light that is transmitted through each element an image can be defined by the LCD device. In addition, the pixel elements may include multiple different color filters, where the amount of white light passing through each filter can be individually-controlled, so that the LCD device can render a color image.

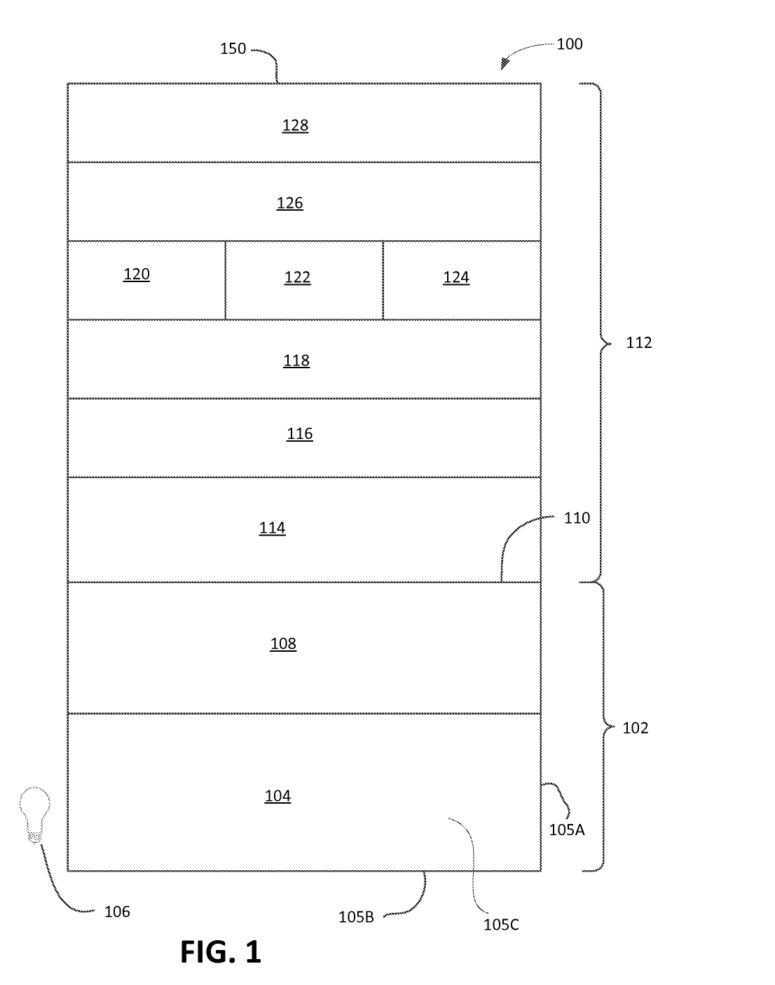

FIG. 1 is an example cross-sectional schematic diagram of pixel element of an LCD device 100. The pixel element can include backlight section 102 and an LCD section 112. The backlight section 102 can include a transparent light guide panel (LGP) 104 that can include glass, plastic, polymer, etc. material, which can transmit or guide light from an edge- or rear-mounted light source 106. In the example implementation shown in FIG. 1, the light source 106 is edge-mounted, in that the light source is mounted proximate to an edge of the LGP 106, so that the light from the source 106 is coupled into the LGP 104 through an edge of the LGP and can traverse the LGP to a side surface of the LGP, which can include a reflecting surface to re-inject light into the LGP 104. Light can also strike a bottom surface 105B of the LGP, where the bottom surface 105B can include a reflecting surface to re-direct light into the LGP 104. Light can also strike side surfaces 105C of the LGP, where the side surfaces can include a reflecting surface to re-direct light into the LGB. The reflecting surfaces that re-direct light into the LGP 104 can include a metallic film, a multilayer dielectric film, etc.

In an example back lit implementation (not shown), the light source 106 can be mounted proximate to the bottom surface 105B of the LGP 104 and coupled through the bottom surface into the LGP. In the backlit implementation both side surfaces of the LGP can include reflecting surfaces to redirect light into the LGP 104.

The LGP 104 is coupled to a diffuser 108 that extracts light from the LGP and directs the light toward the display surface 150 of the LCD pixel element 100. The interface surface 110 of the LGP 104 and the diffuser 108 can be roughened, pitted, dimpled, etc., where the surface features are defined on a scale that is selected to scatter light in the LGP 104 out of the LGP and into the diffuser 108. The bottom surface 105B of the LGP 104 also can be similarly roughened, pitted, dimpled, etc., to scatter light in the LGP 104 out of the LGP and into the diffuser 108. The diffuser 108 can include transparent material that transmits light to the LCD section 112. The diffuser 108 can include a multi-layered optical film stack that includes a diffusing layer, prisms and other optical elements that control the light to create a substantially homogeneous intensity profile over the display surface 150 of the pixel element 100.

The LCD section 112 can include a rear polarizer 114, an addressing structure 116 that may include thin film transistors (TFTs) disposed on a transparent plate, a liquid crystal material layer 118, color filters (e.g., red, green, and blue filters) 120, 122, 124 on a transparent plate, a front polarizer 126, and a protective glass layer 128.

As light traverses, and reflects within, the LGP 104, it can be scattered from the interface 110 of the LGP 104 and the diffuser 108, such that light enters the diffuser and propagates upward though the pixel element 100. Light that passes through the diffuser is polarized by the rear polarizer 114 and then can enter the liquid crystal material layer 118. The TFTs in the addressing structure 116 can control the amount of charge between different regions of the addressing structure 116 and the color filters 120, 122, 124, and the amount of charge determines the degree to which long molecules in the liquid crystal material layer 116 are oriented in such a manner as to act as a selective polarization region that, in conjunction with rear polarizer 114, prevents light from reaching one or more of the color filters 120, 122, 124. In this way, the amount of light that is allowed to pass into the individual color filters 120, 122, 124 is controlled. The color filters 120, 122, 124 filter the light passing through them, and the light is then repolarized by the front polarizer 126 and passes though the cover glass 128 of the display.

The light source 106 can include one or more LEDs. In some implementations, the one or more LEDs can each emit white light. In some implementations, the light sources 106 that produce white light can include multiple LEDs that emit different colors of light, which, when combined, produce white light. More particularly, the combined outputs of the multiple LEDs that emit different colors of light can have an x,y chromaticity coordinate that is close to the chromaticity coordinate of the white point of a standard red, green, blue color space.

In some implementations, the one or more LEDs can emit colored light that, some of which is converted to one or more different colors by optical materials within the LCD device 100. For example, the LCD may include optical materials (e.g., quantum dot materials) that absorb some of the colored light emitted from the LEDs and then re-emit light at one or more longer-wavelength colors. For example, a film of quantum dot materials may be provided between the diffuser 108 and the LCD section 112. The combination of the colored light that passes through the materials and the color(s) of the light re-emitted from the material can be viewed as white light.

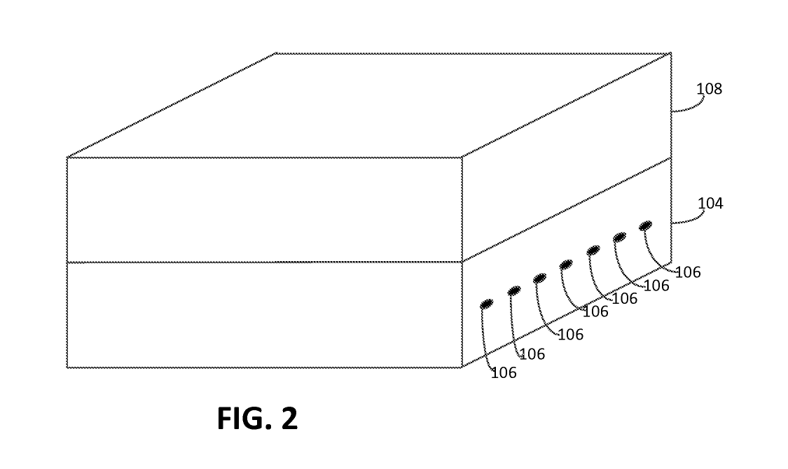

FIG. 2 is a schematic perspective view of the LGP 104 and the diffuser 108. Multiple light sources 106 are positioned at an edge of the LGP 104, so that light emitted from the sources enters the LGP. As the light propagates through the LGP 104, most of the light is coupled upward into the diffuser 108, so that it can be used to illuminate the LCD portion 112 of the device. The multiple light sources can be mounted on one or more printed circuit boards (PCB), which may include a flexible substrate.

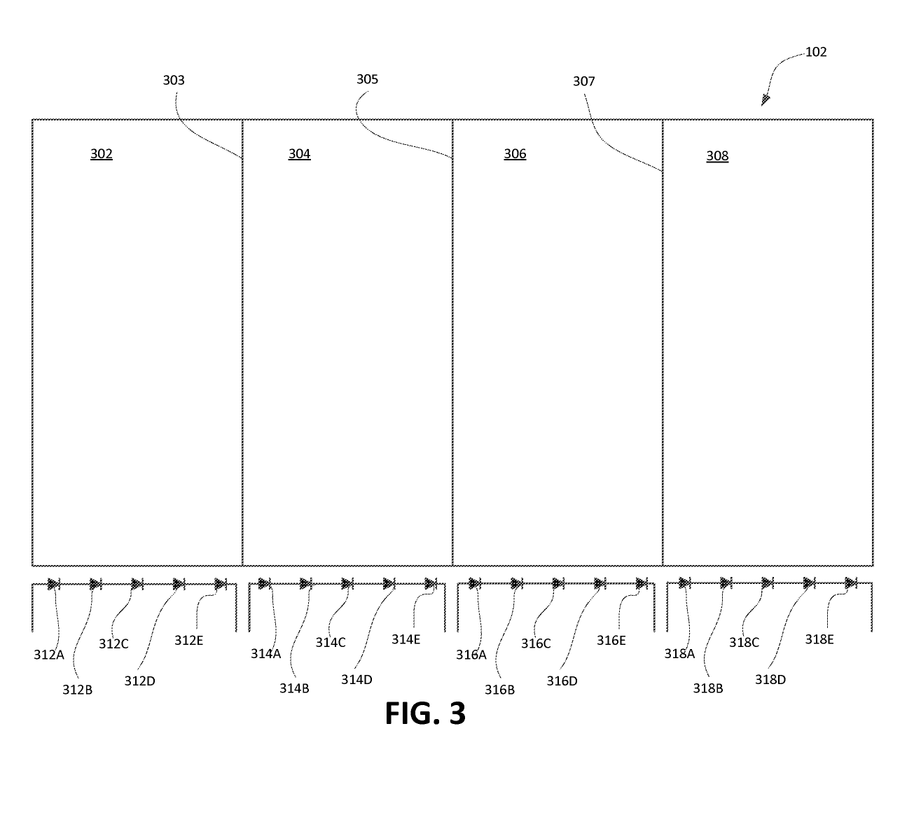

FIG. 3 is a schematic top view of the backlight section 102 of the display device, according to an example implementation. The backlight section 102 can include a plurality of different individual regions 302, 304, 306, 308, where the different individual regions are each associated with one or more different individual light sources. For example, region 302 can be associated with light sources 312a, 312b, 312c, 312d, 312e; region 304 can be associated with light sources 314a, 314b, 314c, 314d, 314e; region 306 can be associated with light sources 316a, 316b, 316c, 316d, 316e; and region 308 can be associated with light sources 318a, 318b, 318c, 318d, 318e. Four different individual regions are shown in FIG. 3, but a different number of individual regions can be used. In some implementations, the light sources can be light emitting diodes.

In some implementations, to efficiently manage the energy consumption of the backlight display while also providing information to the user through a well-lit display, one or more light sources associated with a particular individual region of the backlight section 102 can be turned on while light sources not associated with the individual region are not turned on. That is, the one or more light sources associated with particular individual regions of the backlight section 102 can be separately controlled to provide backlight illumination separately to the different regions. In this manner, backlight illumination can be provided only to the particular individual region, and information can be provided on the particular individual region of the display, while other regions of the display are not backlit, thereby reducing the energy consumption of the backlight display compared to when all of the regions are provided with backlight illumination.

In some implementations, a single unitary LGP 104 can be used in the display, and the different individual regions 302, 304, 306, 308 of the backlight section 102 can be defined based on an association of the different regions with different respective light sources that are separately controlled. For example, the group of light sources 312a, 312b, 312c, 312d, 312e are most closely proximate to region 302, and the group of light sources 314a, 314b, 314c, 314d, 314e are most closely proximate to region 304, etc. In such implementations, when backlight illumination is provided only to one particular individual region, light injected from sources associated with the particular individual region may diffuse within the LGP 104 and/or the diffuser 108 into other individual regions, although the backlight illumination will be brightest in the particular individual region.

In some implementations, the LGP 104 can include individual regions 302, 304, 306, 308 that are somewhat optically isolated from each other. For example, reflecting surfaces in the LGP 104 and/or the diffuser 108 at the boundaries 303, 305, 307 between different individual regions can be used to re-direct light injected into a particular individual region back into the particular individual region. For example, when backlight illumination is injected from the group of light sources 312a, 312b, 312c, 312d, 312e into the particular individual region 302 and then strikes a reflecting surface 303 at the boundary between region 302 and 304, the light may be re-directed back into region 302, rather than crossing over into region 304. Optically-isolated individual regions can be created in a variety of ways. For example, the portions of the LGP 104 and/or the diffuser 108 associated with particular individual regions can be fabricated separately, with reflecting surfaces at their edges, and then can be combined (e.g., laminated together) to create the LGP 104 for the display device 102. In another example, a single LGP 104 and/or diffuser 108 can be fabricated with reflecting surfaces within it. For example, a single LGP 104 can be grown by a process of flowing a first portion of transparent material, to be associated with region 302, into a mold, then depositing a reflecting layer to be associated with boundary 303, then flowing a second portion of transparent material, to be associated with region 304 into the mold, then depositing a reflecting layer to be associated with boundary 305, etc.

A computing device having a backlit display that includes a plurality of different individual regions 302, 304, 306, 308 associated with different light sources 312, 314, 316, 318 that can be controlled separately from each other can be used to display information to a user of the computing device in an energy efficient manner. For example, when the computing device is being used in a low power, or energy-saving, mode a subset of the different individual regions can be provided with backlight illumination, while other regions are not provided with backlight illumination. Then, information can be displayed on the illuminated region of the backlit display.

For example, when the computing device is used in a low-power or energy-saving mode, the device may place cut or reduce power to unneeded subsystems. The device may also place random access memory of the device into a minimum power state that is sufficient to retain its data. However, the device may be periodically woken from its low-power or energy-saving mode to check for any incoming or upcoming events that can be reported to the user of the device. For example, the device may check for events signifying the receipt of messages (e.g., email, SMS, voicemail, chat, etc.), may check for upcoming events (e.g., an approaching calendar event, an alarm, etc.), may check for messages from an application (e.g., notifications from a social media application, a game application, a weather application, etc.), may check for status updates (e.g., regarding battery charge, available disk space, etc.), etc. Information about the events can be provided to a user using a subset of the individual regions of the backlight display, while other regions are not provided with backlight illumination.

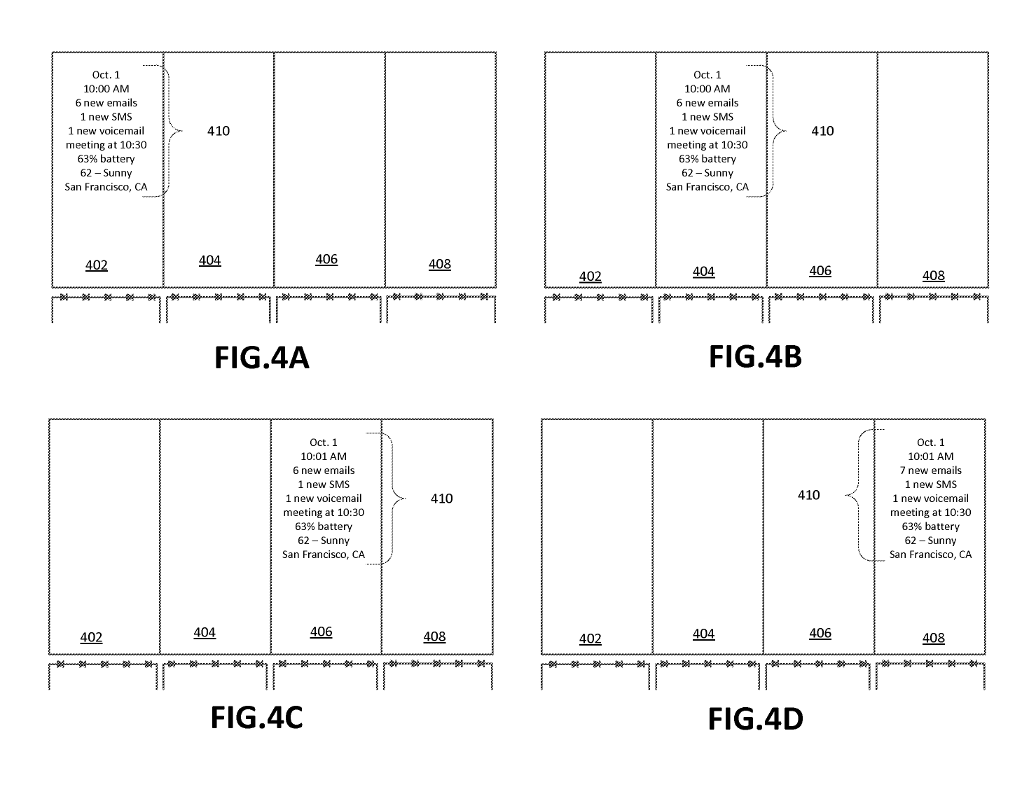

FIG. 4A, FIG. 4B, FIG. 4C, FIG. 4D are schematic diagrams of the display of information on an individual region of a backlight display with, while other regions of the backlight display are not provided with backlight illumination. As shown in FIG. 4A, information can be displayed in a first region of the backlight display 402, while backlight illumination is not provided to other regions 404, 406, 408. As shown in FIG. 4A, information 410 can be provided about a current date, a current time, a number of unread email messages, a number of unread SMS messages, a number of unread voicemails, a notification of an upcoming meeting, and weather conditions at a location. Of course, other information can be provided in the particular individual region of the backlight display. The information that is displayed in an individual region of the backlight display can be cycled for display to different individual regions. For example, the information 410 can be displayed in region 402 at a first time, while backlight illumination is not provided to regions 404, 406, 408. The information 410 can be displayed in a second region 404 at a second time that is later than the first time, while backlight illumination is not provided to regions 402, 406, 408. The information 410 can be displayed in region 406 at a third time that is later than the second time, while backlight illumination is not provided to regions 402, 404, 408. The information 410 can be displayed in region 408 at a fourth time that is later than the third time, while backlight illumination is not provided to regions 402, 404, 406. The difference between the information displayed at the third time in region 406 and the information displayed at a fourth time in region 408 indicates that an additional new email arrived at the computing device between the third time in the fourth time. The information 410 displayed in an individual region of the backlight display can be updated in real-time by the computing device.

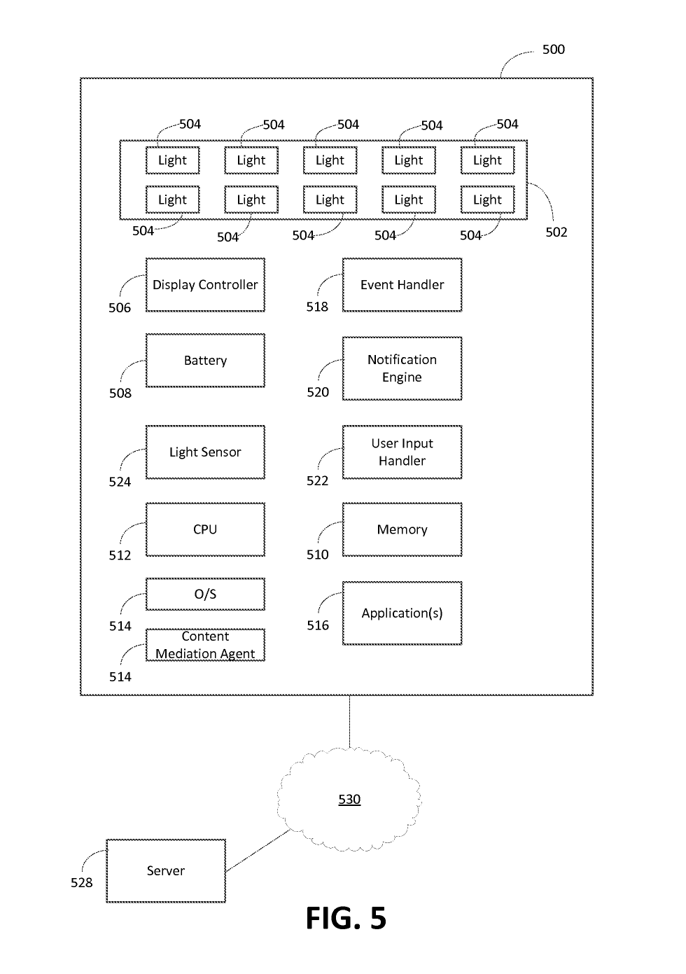

FIG. 5 is a schematic diagram of a computing device 500 that includes a backlit display 502 that is illuminated by a plurality of light sources 504. The computing device 500 can take a variety of different forms. For example, the computing device 500 can be a tablet, a mobile phone, a laptop computer having a base portion that includes a keyboard and a display portion. The backlit display includes a plurality of different individual regions, and each light source 504 is associated with at least one, but not all of the plurality of different individual regions. In some implementations, the area of the backlight display can be greater than five square inches, and the backlight display can include at least three different individual regions. The different individual regions can all be the same size and shape, or they can be different sizes, and/or different shapes. The computing device 500 includes a display controller 506 that can control the power (e.g., current) provided to different ones of the plurality of light sources 504. The computing device 500 includes a battery 508 that can supply the power that is provided to the light sources 504.

The computing device 500 includes at least one memory 510 that can store instructions that can be executed by at least one processor 512. The instructions can be executed to provide an operating system 514 and one or more applications 516. The computing device includes an event handler 518 that can detect the occurrence of an event that may be handled by a program installed on the computing device, where the program can include the operating system 514, one or more applications 516, firmware, etc. The computing device 500 also includes a notification engine 520 that can respond to the detection of an occurrence of an event by the event handler 518 to provide a visual notification in the backlit display 502 to a user regarding the detection of the event. In some implementations, the visual notification can be provided to the user within a single individual region of the backlight display, or a subset of all of the regions of the backlight display, while backlight illumination is not provided to other regions of the backlight display. For example, when the event handler 518 detects the occurrence of an incoming email message, the notification engine 520 can respond to this detection by providing a visual notification of the event within one region of the backlit display 502, while backlight illumination is not provided to the other individual regions of the backlight display.

The computing device can include a user input handler 522 that can receive a user's selection of the visual notification that is provided in the single region of the backlight display or that is provided in a subset of all of the regions of the backlight display, while backlight illumination is provided to the other region of the backlight display. The user's interaction may be in the form of touching the visual indicator, when the backlight display includes a touch sensitive surface, or receiving a mouse click on the visual indicator, or receiving a voice command relevant to the visual indicator.

In response to receiving the user selection of the visual indicator, the display controller can turn on at least some of the light sources that have not previously been turned on to provide backlight illumination to all of the individual regions of the backlight display, so that the entire backlight display is provided with backlight illumination. In this manner, the backlight display may automatically respond to the user's interaction with a visual notification provided in an individual region of the backlight display by returning the display to a full-screen mode in which the entire backlight display is provided with backlight illumination. This may be useful, because the user's interaction with a visual indicator corresponding to a notification may indicate that the user wishes to launch a program to respond to the notification, and the program may be best executed when the entire backlight play is provided with backlight illumination. For example, the user's selection of a visual indicator of a new email message may indicate that the user wishes to launch a program to read or respond to the new email message, and the program may be best utilized when the entire backlight display is provided with backlight illumination. When all of the different individual regions are provided with backlight illumination, the brightness of the backlight emitted from a surface of each of the individual regions can be approximately equal, so that the boundaries between the different regions are not noticeable to the user. Factory calibration can ensure equal brightnesses of the different individual regions.

The computing device 500 can include a light sensor 524 that senses an ambient light level at the computing device. The display controller 506 can control the power provided to the light sources based on the sensed ambient light level. For example, for dark conditions, a relatively low amount of power can be provided to the light sources, while a relatively large amount of light power can be provided when bright ambient conditions are sensed.

In some implementations, the form of a visual notification that is provided in response to detecting the occurrence of an event can depend on whether backlight illumination is provided to all of the different individual regions (i.e., when the backlight display is in a full-screen mode) or whether backlight illumination is provided to only one, or a subset, of the different individual regions. For example, when backlight illumination is provided to only a subset of the individual regions, and only a portion of the entire area of the display is available for providing information to a user, a visual indicator of a detected event can have a first form, and when the computing devices in a full-screen mode and the entire area of the display is available for providing information, the visual indicator can have a second form. For example, when the event is the detection of an incoming email message, the first form can be similar to a visual indicator that would be provided on a mobile phone to alert the user about an incoming email message, and the second form can be similar to a visual indicator that would be provided on a full-screen display of a desktop computer or of a relatively large laptop computer.

In some implementations, the duration of time over which a visual indicator of the occurrence of an event can depend on whether backlight illumination is provided to all of the different individual regions or whether backlight illumination is provided to only one, or a subset, of the different individual regions. For example, when backlight illumination is provided to only a subset of the individual regions, a visual indicator of a detected event can be provided for a first period of time, and when the computing devices in a full-screen mode and the entire area of the display is available for providing information, the visual indicator can be provided for a second period of time. The first period of time can be longer than the second period of time, because when the backlight illumination is provided to only one region the user may not be actively engaged, and looking at, the display, whereas when the backlight illumination is provided to the entire display it may be assumed that the user is actively engaged with the display and may want only a brief notification of the event before the notification is removed.

In some implementations, the backlight display 502 having a plurality of light sources 504 associated with different individual regions of the display can be used to provide content to a user in a form, or version, a depends on whether backlight illumination is provided to all of the regions of the display or to only a subset of the regions. The computing device 500 can include a content mediation agent 526 that determines a version of content to be rendered by a content rendering program. The determination of the version to be rendered can be based on whether backlight illumination is provided to all of the individual regions of the backlight display or to only a subset of the regions.

For example, a webpage that is hosted by a server computer 528 and whose content is transmitted to the computing device 500 through a network 530 (e.g., the Internet) can be displayed to a user through a browser application in a first version, when all of the different regions of the backlight display are provided with backlight illumination and can be displayed in a second version when the page is displayed in only one region, or a subset of all of the regions, that is/are provided with backlight illumination. The first version can be, for example, a version of the webpage that is generally provided to displays having a size that is larger than a threshold size (e.g., eight inches diagonal), and the second version can be a version of the webpage that is generally provided to devices (e.g., mobile phones) having a display with a size that is smaller than a threshold size (e.g., five inches diagonal). The server 528 may maintain different versions of the webpage that can be served to a device depending on the local resources of the device that are used to render the webpage. The content mediation agent 526 can insert information into a request from the computing device 500 to the server 528 for the webpage, based on whether the backlight display 502 is providing illumination to all of the different regions of the display or to only a subset of the regions, which causes the server 528 to respond to the request by sending the first version of the webpage that is suitable for display using the entire area of the backlight display 502 or by sending the second version of the webpage that is suitable for display using the area of the display corresponding to a subset of all of the regions of the display. In some implementations, the inserted information can include a screen resolution in pixels of the region(s) of the backlight display that are provided with backlight illumination. In some implementations, the inserted information can include a size of the region(s) of the backlight display that are provided with backlight illumination. In some implementations, the information can be provided in a user agent that is communicated from the browser application executing on the computing device 500 to the server computer 528.

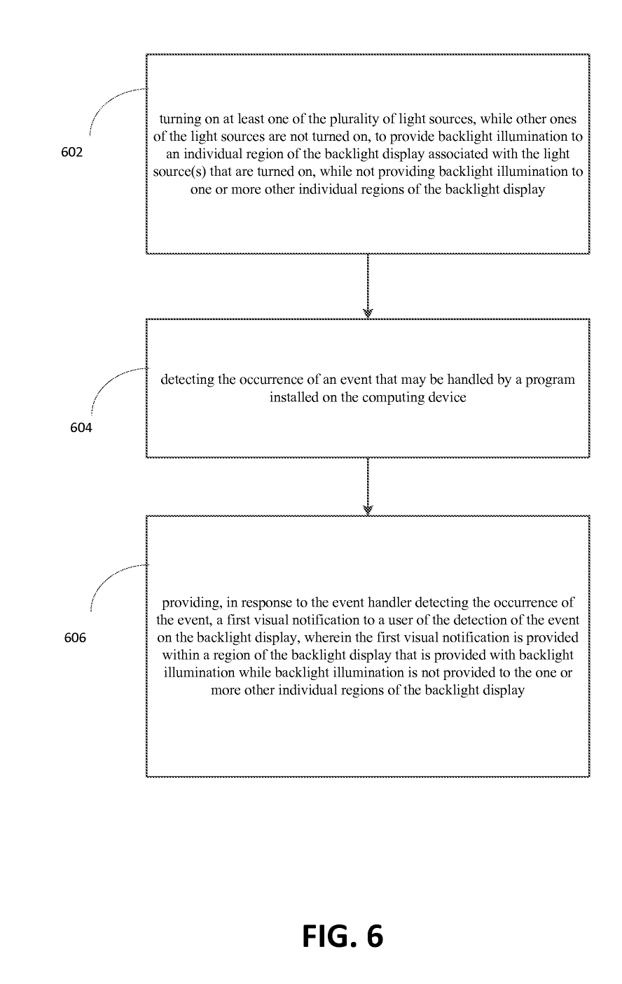

FIG. 6 is a flowchart 600 illustrating example operations of a process 600 of providing a notification in a computing device having a backlight display that includes a plurality of light sources, each light source being associated with at least one, but not all, of a plurality of different individual regions of the backlight display. The process 600 can include turning on at least one of the plurality of the light sources, while other ones of the light sources (602). The light sources that are turned on can provide backlight illumination to an individual region of the backlight display that is associated with the light source(s) that are turned on, while not providing backlight illumination to other individual regions of the backlight display. The occurrence of an event that may be handled by a program installed on the computing device can be detected (604). In response to detecting the occurrence of the event, a first visual notification can be provided to the user in the backlight display; and the first visual notification of the detection of the event can be provided within a region of the backlight display that is provided with backlight illumination, while backlight illumination is not provided to the other individual regions of the backlight display (606).

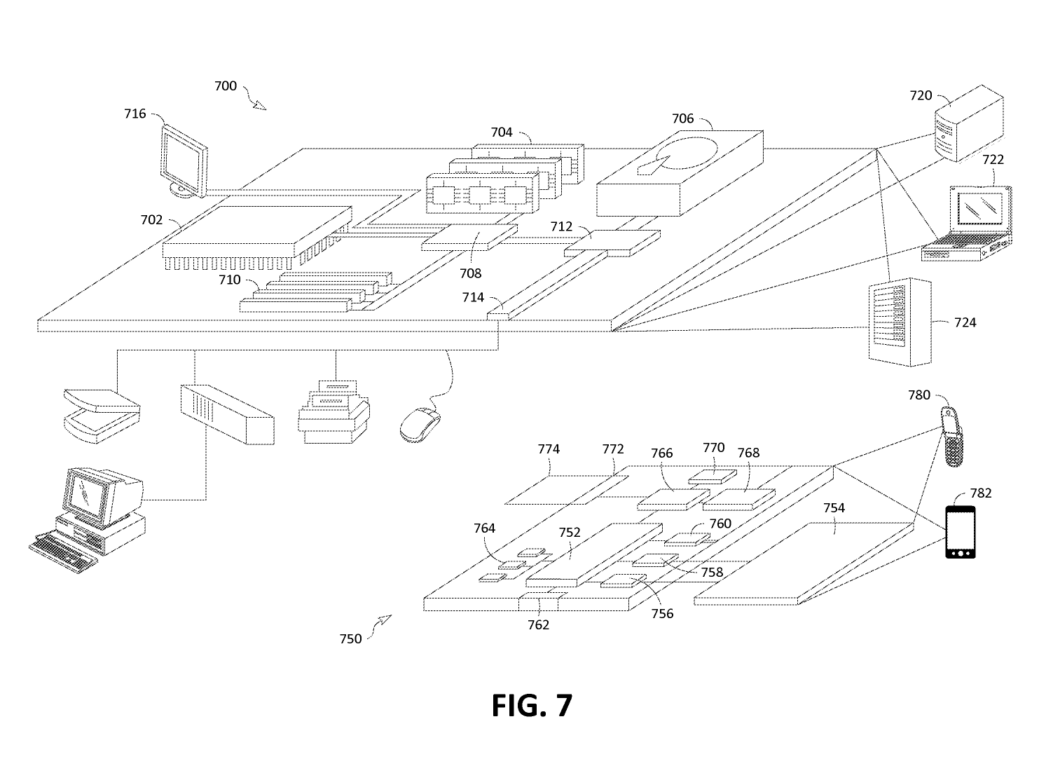

FIG. 7 shows an example of a generic computer device 700 and a generic mobile computer device 750, which may be used with the techniques described here. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smart phones, televisions, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752, that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smart phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, such as LCD (liquid crystal display) monitor for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computing device comprising:
a backlight display including a plurality of light sources, each light source being associated with at least one, but not all, of a plurality of different individual regions of the backlight display; and
a display controller configured to turn on at least one of the plurality of light sources, while other ones of the light sources are not turned on, to provide backlight illumination to an individual region of the backlight display associated with the light source(s) that are turned on, while not providing backlight illumination to one or more other individual regions of the backlight display;
an event handler configured to detect an occurrence of an event that may be handled by a program installed on the computing device; and
a notification engine configured to, in response to the event handler detecting the occurrence of the event, provide a first visual notification to a user of the detection of the event on the backlight display, wherein the first visual notification is provided within a region of the backlight display that is provided with backlight illumination while backlight illumination is not provided to the one or more other individual regions of the backlight display.

2. The computing device of claim 1, wherein the plurality of different individual regions are adjacent to each other.

3. The computing device of claim 1, wherein the computing device includes a base portion and a display portion, the display portion including the backlight display, and the base portion including a keyboard.

4. The computing device of claim 1, wherein an area of the backlight display is greater than five square inches, and wherein the plurality of different individual regions of the backlight display includes at least three different individual regions.

5. The computing device of claim 1, wherein the plurality of different individual regions of the backlight display includes at least three different regions and wherein areas of the different regions are approximately equal.

6. The computing device of claim 1, wherein the display controller is further configured to:
sequentially turn on one of more different ones of the plurality of light sources, while other ones of the light sources are not turned on, to sequentially provide backlight to different individual regions of the backlight display associated with the different light sources that are sequentially turned on, while not providing backlight to one or more other individual regions of the backlight display, and
sequentially provide the first visual notification to the user within the different regions of the backlight display that are provided with backlight.

7. The computing device of claim 1, further comprising:
an ambient light sensor,
wherein the display controller is further configured to control, based on an ambient light level detected by the sensor, a brightness of the light sources that are turned on.

8. The computing device of claim 1, wherein the notification includes one of an incoming call, incoming call email, incoming call SMS message, or a reminder of calendar event.

9. The computing device of claim 1, further comprising:
a user input handler configured to receive a user's selection of the first visual notification; and
wherein the display controller is further configured to, in response to the received user's selection, turn on at least some of the light sources that had not been turned on to provide backlight illumination to all of the individual regions of the backlight display, wherein a brightness of the backlight illumination provided to each of the individual regions is approximately equal.

10. The computing device of claim 1, wherein the display controller is further configured to:
turn on multiple ones of the light sources to provide backlight to all the individual regions of the backlight display, wherein a brightness of the backlight provided to each of the individual regions is approximately equal.

11. The computing device of claim 1, wherein the notification engine is further configured to, in response to the event handler detecting the occurrence of the event when multiple ones of the light sources are turned on to provide backlight illumination to all the individual regions of the backlight display, provide, to the user, a second visual notification of the detection of the event on the backlight display, wherein the second visual notification is different than the first visual notification.

12. The computing device of claim 11,
wherein the notification engine is configured to provide the first visual notification for a first time period when backlight illumination is not provided to the one or more other individual regions of the backlight display,
wherein the notification engine is configured to provide the second visual notification for a second time period when backlight illumination is provided to all of the individual regions of the backlight display, and
wherein the first time period is longer than the second time period.

13. A method of providing a notification in a computing device having a backlight display that includes a plurality of light sources, each light source being associated with at least one, but not all, of a plurality of different individual regions of the backlight display, the method comprising:
turning on at least one of the plurality of light sources, while other ones of the light sources are not turned on, to provide backlight illumination to an individual region of the backlight display associated with the light source(s) that are turned on, while not providing backlight illumination to one or more other individual regions of the backlight display;
detecting an occurrence of an event that may be handled by a program installed on the computing device; and
providing, in response detecting the occurrence of the event, a first visual notification to a user of the detection of the event on the backlight display, wherein the first visual notification is provided within a region of the backlight display that is provided with backlight illumination while backlight illumination is not provided to the one or more other individual regions of the backlight display.

14. The method of claim 13, further comprising:
sequentially turning on one of more different ones of the plurality of light sources, while other ones of the light sources are not turned on, to sequentially provide backlight to different individual regions of the backlight display associated with the different light sources that are sequentially turned on, while not providing backlight to one or more other individual regions of the backlight display, and
sequentially providing the first visual notification to the user within the different regions of the backlight display that are provided with backlight.

15. The method of claim 13, further comprising:
detecting an ambient light level at the computing device; and
based on the detected ambient light level, determining a brightness of the light sources that are turned on.

16. The method of claim 13, wherein the notification includes one of an incoming call, incoming call email, incoming call SMS message, or a reminder of calendar event.

17. The method of claim 13, further comprising:
receiving a user's selection of the first visual notification; and
in response to the received user's selection, turning on at least some of the light sources that had not been turned on to provide backlight illumination to all of the individual regions of the backlight display, wherein a brightness of the backlight illumination provided to each of the individual regions is approximately equal.

18. The method of claim 13, further comprising:
in response detecting the occurrence of the event when multiple ones of the light sources are turned on to provide backlight illumination to all the individual regions of the backlight display, providing, to the user, a second visual notification of the detection of the event on the backlight display, wherein the second visual notification is different than the first visual notification.

19. The method of claim 18, further comprising:
providing the first visual notification for a first time period when backlight illumination is not provided to the one or more other individual regions of the backlight display; and
providing the second visual notification for a second time period when backlight illumination is provided to all of the individual regions of the backlight display,
wherein the first time period is longer than the second time period.

20. A computing device, comprising:
a backlight display including a plurality of light sources, each light source being associated with at least one, but not all, of a plurality of different individual regions of the backlight display;
a display controller configured to:
(a) turn on at least one of the plurality of light sources, while other ones of the light sources are not turned on, to provide backlight illumination to an individual region of the backlight display associated with the light source(s) that are turned on, while not providing backlight illumination to one or more other individual regions of the backlight display, and
(b) turn on multiple ones of the light sources to provide backlight illumination to all the individual regions of the backlight display, wherein a brightness of the backlight provided to each of the individual regions is approximately equal;
one or more processors configured to execute a content rendering program; and
a content mediation agent configured to determine a version of content requested by the content rendering program to be rendered by the program, wherein the determination of the version to be rendered is based on whether backlight illumination is provided to all the individual regions of the backlight display or whether backlight illumination is provided to an individual region of the backlight display, while backlight illumination is not provided to other regions of the display.

21. The computing device of claim 20,
wherein the content-rendering program includes a browser,
wherein the content requested to be rendered includes content from a webpage,
wherein a version of the content from the webpage to be rendered when backlight illumination is provided to all the individual regions of the backlight display includes a version of the webpage intended for rendering on displays having a diagonal dimension of greater than eight inches, and
wherein a version of the content from the webpage to be rendered when backlight illumination is provided to an individual region of the backlight display, while backlight illumination is not provided to other regions of the display includes a version of the webpage intended for rendering on displays having a diagonal dimension of less than five inches.

22. The computing device of claim 20, wherein determining the version of content to be rendered includes specifying a browser user agent that is communicated from the computing device to a server hosting the content.
